(19) United States
(12) Patent Application Publication
(10) Pub. No.: US 2019/0041802 A1
(43) Pub. Date: Feb. 7, 2019

(54) Watch Case

(71) Applicant: Shenzhen Singems Timepieces & Jewellery Co., Ltd., Shenzhen (CN)

(72) Inventor: Mingda Liang, Shenzhen (CN)

(21) Appl. No.: 16/055,188

(22) Filed: Aug. 6, 2018

(30) Foreign Application Priority Data
Aug. 7, 2017 (CN) 201720975869.7

(51) Int. Cl. G04B 37/22

(52) U.S. Cl. CPC G04B 37/22; G04B 37/1486

(57) ABSTRACT

The present invention relates to the field of clocks and watches and discloses a watch case comprising a main case body and two case lugs. Two symmetric concave embedded portions are arranged on the outer bottom edge of the main case body. The case lugs are provided with first connecting portions matched with the embedded portions, and are connected to the embedded portions via the first connecting portions in a detachable manner to fit with the main case body. Therefore, the present invention has a simple structure and may be used in automatic production to save production material cost and labor cost.

### CROSS REFERENCE TO RELATED APPLICATIONS

The present application claims the benefit of Chinese Patent Application No. 201720975869.7 filed on Aug. 7, 2017. All the above are hereby incorporated by reference.

### FIELD OF INVENTION

The present invention relates to the technical field of clocks and watches, particularly to a watch case.

### BACKGROUND

The cases of existing watches are integrally molded with case lugs in general, while the structure of an integrally molded watch case is relatively complex, so the stamping or hydraulic pressing operation of the integral molding is relatively complex, too. Moreover, fixing case lugs on a watch case is also not conducive to the disassembly and replacement of the watch band.

To sum up, the prior art obviously has convenience and defect in actual use, so improvement is necessary.

### SUMMARY OF THE INVENTION

To tackle the foregoing defect, the object of the present invention is to provide a watch case, which has a simple structure, may be used in automatic production, saves production cost and labor cost, and makes for disassembly and replacement of the watch case.

To realize the foregoing object, the present invention provides a watch case comprising a main case body and two case lugs. Two symmetric concave embedded portions are arranged on the outer bottom edge of the main case body. The case lugs are provided with first connecting portions matched with the embedded portions, and are connected to the embedded portions via the first connecting portions in a detachable manner to fit with the main case body.

According to the watch case described in the present invention, the main case body is integrally molded by stamping and/hydraulic pressing.

According to the watch case described in the present invention, the two embedded portions correspond to the internal bulges of the main case body to form two placement portions so as to place the dial component.

According to the watch case described in the present invention, threaded connection is adopted between the embedded portions and the first connecting portions.

According to the watch case described in the present invention, each of the embedded portions is provided with at least one through first screw hole, each of the first connecting portions is provided with a blind second screw hole corresponding to the first screw hole, and a bolt is screwed through the first screw hole till the second screw hole to connect and fix the embedded portion and the first connecting portion.

According to the watch case described in the present invention, each of the case lugs is further provided with a second connecting portion connected to a watch band module in a detachable manner.

According to the watch case described in the present invention, the main case body is in a disc shape with a hollow middle part and further comprises a top cover and a bottom cover, which are mounted to the top surface and bottom surface of the main case body in a detachable manner.

According to the watch case described in the present invention, a knob mounting hole is arranged on the external wall of the main case body.

According to the watch case described in the present invention, the main case body and /or the case lugs are made of metallic materials.

The watch case described in the present invention comprises a main case body and two case lugs, two symmetric concave embedded portions are arranged on the outer bottom edge of the main case body, and the case lugs are provided with first connecting portions matched with the embedded portions, and are connected to the embedded portions via the first connecting portions in a detachable manner to fit with the main case body. Therefore, the present invention has a simple structure and may be used in automatic production to save production material cost and labor cost and make for the disassembly and replacement of the watch band.

### BRIEF DESCRIPTION OF THE DRAWING

FIG. 1 is a structural schematic top view of a watch case described in a preferred embodiment of the present invention.

FIG. 2 is a structural schematic bottom view of a watch case described in a preferred embodiment of the present invention.

FIG. 3 is a structural schematic front view of a watch case described in a preferred embodiment of the present invention.

FIG. 4 is a structural schematic view of section A-A in FIG. 1.

FIG. 5 is a structural schematic bottom view of a main case body in a preferred embodiment of the present invention.

FIG. 6 is a structural schematic front view of a main case body in a preferred embodiment of the present invention.

FIG. 7 is a structural schematic right view of a main case body in a preferred embodiment of the present invention.

FIG. 8 is a structural schematic front view of a case lug in a preferred embodiment of the present invention.

FIG. 9 is a structural schematic back view of a case lug in a preferred embodiment of the present invention.

### DETAILED DESCRIPTION OF PREFERRED EMBODIMENTS

The present invention will now be described by referring to the accompanying drawings that illustrate the embodiments of the invention, from which its objects, technical solutions and advantages will be evident. It should be understood that the embodiments described here are intended to illustrate and not to limit the present invention.

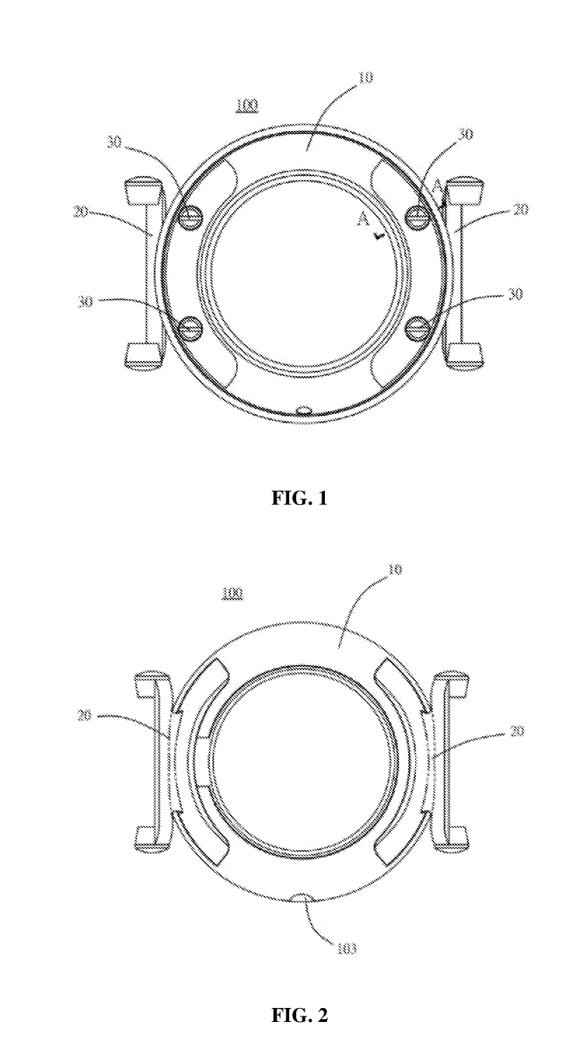

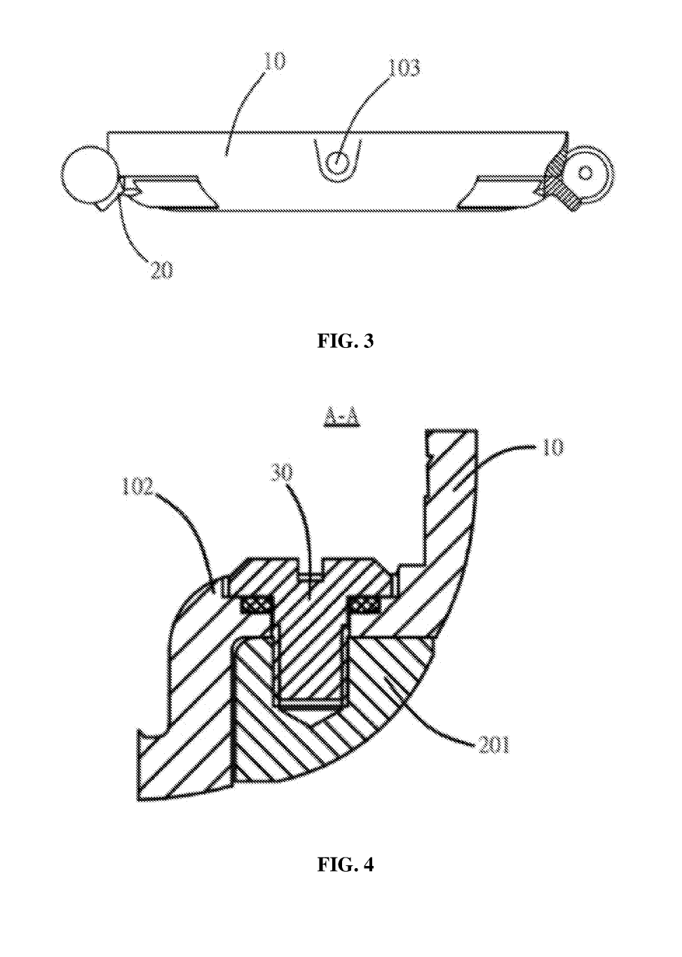

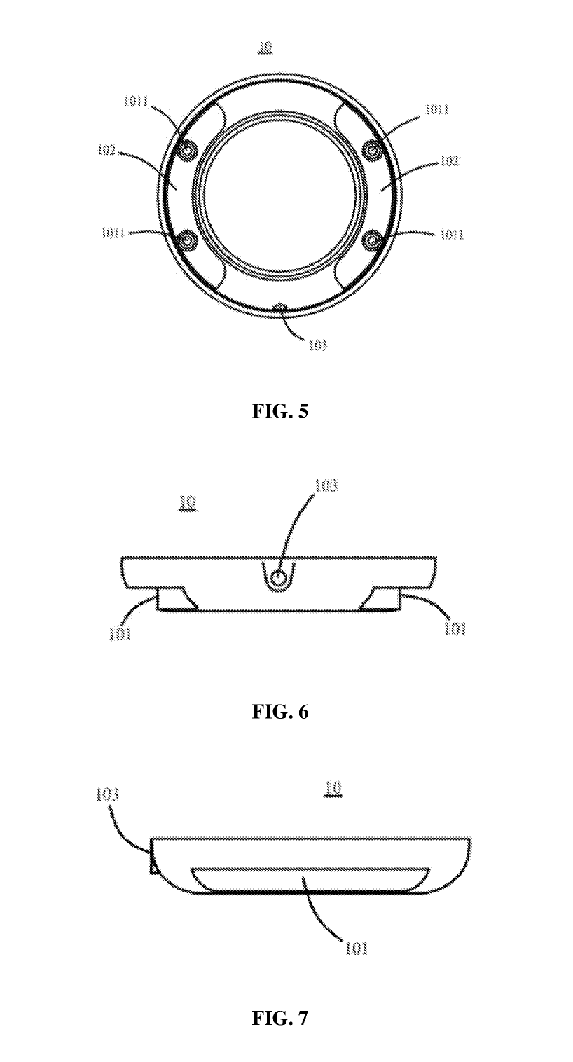

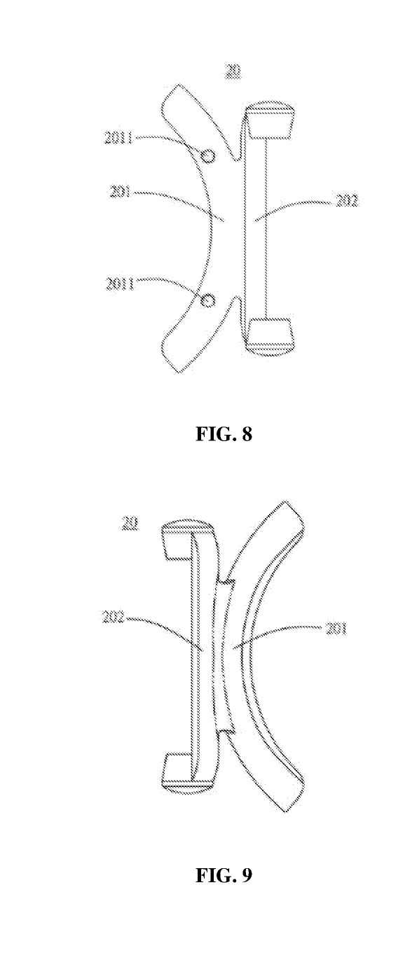

FIG. 1˜FIG. 9 show that the present invention is preferably a watch case 100 comprising a main case body 10 and two case lugs 20. Two symmetric concave embedded portions 101 are arranged on the outer bottom edge of the main case body 10. The case lugs 20 are provided with first connecting portions 201 matched with the embedded portions 101, and are connected to the embedded portions 101 via the first connecting portions 201 in a detachable manner to fit with the main case body 10. As shown in the figures, the embedded portions 101 are formed from the inward depression of the main case body 10, and the shape of the first connecting portions 201 of the case lugs 20 is matched with the embedded portions 101. In other words, when the first connecting portions 201 are connected to the embedded portions 101, they can perfectly fit and fill up the external bottom surfaces of the depressions of the main case body 10. The structure is simple and makes for production. Furthermore, detachable case lugs 20 make the replacement of a watch band more convenient.

The main case body 10 is integrally molded by stamping and/hydraulic pressing. Preferably, a thin sheet is used and made into the main case body 10 by method of stamping and/or hydraulic pressing. As it has a simple structure and may be directly used in automatic production, it can be processed more efficiently, makes for batch production and saves production cost and labor cost.

This embodiment prefers that the main case body 10 is in a disc shape with a hollow middle part and further comprises a top cover (not shown in the figures, such as a glass top cover) and a bottom cover (not shown in the figures, such as a metal bottom cover), which are mounted to the top surface and bottom surface of the main case body 10 in a detachable manner respectively. Of course, the main case body 10 may be in other polygonal shapes with a hollow middle part, such as rectangle and polynedron. Further, the two embedded portions 101 are arranged on the two sides of the main case body 10 symmetrically and in an arc shape and the first connecting portions 201 fit with the embedded portions 101.

As shown in FIG. 4, to be specific, the two embedded portions 101 correspond to the internal bulges of the main case body 10 to form two placement portions 102 to place the dial component. The two placement portions 102 are symmetric on the inner edge of the main case body 10 and equally high, both lower than the upper edge of the main case body 10.

Preferably, threaded connection is adopted between the embedded portions 101 and the first connecting portions 201. Of course, other connecting methods may be adopted, too.

To be specific, each of the embedded portions 101 is provided with at least one through first screw hole 1011, each of the first connecting portions 201 is provided with a blind second screw hole 2011 corresponding to the first screw hole 1011, and a bolt 30 is screwed through the first screw hole 1011 till the second screw hole 2011 to connect and fix the embedded portion 101 and the first connecting portion 201. Each of the embedded portions 101 in this embodiment is provided with two symmetric first screw holes 1011, and the first connecting portion 201 of each case lug 20 is provided with two corresponding second screw holes 2011. As the second screw hole 2011 is not through, so when a bolt is screwed from the inside of the main case body 10 through the first screw hole 1011 till the second screw hole 2011, it does not run through the outer bottom surface to facilitate good waterproofing performance.

Each of the case lugs 20 is further provided with a second connecting portion 202 connected to the watch band module in a detachable manner, i.e., the first connecting portion 201 of the case lug 20 is connected to the main case body 10, and connected to the watch band via the second connecting portion 202.

A knob mounting hole 103 is arranged on the exterior wall of the main case body 10 and used to mount a knob or a key.

Preferably, the main case body 10 and/or the case lugs 20 are made of metallic materials.

To sum up, the watch case described in the present invention comprises a main case body and two case lugs, two symmetric concave embedded portions are arranged on the outer bottom edge of the main case body, and the case lugs are provided with first connecting portions matched with the embedded portions, and are connected to the embedded portions via the first connecting portions in a detachable manner to fit with the main case body. Therefore, the present invention has a simple structure and adopts automatic integral molding. It saves production cost and labor cost. The cost is low and the production is easy.

Of course, the present invention may also have other various embodiments. Without departing from the spirit and essence of the present invention, those skilled in the art may make various changes and modifications to the present invention, but these changes and modifications all shall be within the protection scope of the claims of the present invention.

What is claimed is:

1. A watch case comprising a main case body and two case lugs, wherein two symmetric concave embedded portions are arranged on the outer bottom edge of the main case body, and the case lugs are provided with first connecting portions matched with the embedded portions, and the case lugs are connected to the embedded portions via the first connecting portions in a detachable manner to fit with the main case body.

2. The watch case according to claim 1, wherein the main case body is integrally molded by stamping and/or hydraulic pressing.

3. The watch case according to claim 1, wherein the two embedded portions correspond to internal bulges of the main case body so as to form two placement portions to place the dial component.

4. The watch case according to claim 1, wherein threaded connection is adopted between the embedded portions and the first connecting portions.

5. The watch case according to claim 4, wherein each of the embedded portions is provided with at least one through first screw hole, each of the first connecting portions is provided with a blind second screw hole corresponding to the first screw hole, and a bolt is screwed through the first screw hole till the second screw hole to connect and fix the embedded portion and the first connecting portion.

6. The watch case according to claim 1, wherein each of the case lugs is further provided with a second connecting portion connected to a watch band module in a detachable manner.

7. The watch case according to claim 1, wherein the main case body is in a disc shape with a hollow middle part and further comprises a top cover and a bottom cover, which are mounted to the top surface and bottom surface of the main case body respectively in a detachable manner.

8. The watch case according to claim 1, wherein a knob mounting hole is arranged on the external wall of the main case body.

9. The watch case according to claim 1, wherein the main case body and/or the case lug are made of metallic materials.
